(19) United States
(12) Patent Application Publication
(10) Pub. No.: US 2002/0180733 A1
(43) Pub. Date: Dec. 5, 2002

(54) Method and apparatus for adjusting an image to compensate for an offset position of a user

(75) Inventors: Antonio J. Colmenarez, Peekskill, NY (US); Srinivas Gutta, Buchanan, NY (US); Daniel Pelletier, Lake Peekskill, NY (US); Miroslav Trajkovic, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/858,211

(22) Filed: May 15, 2001

(51) Int. Cl. G06T 15/10; G06T 15/20; G09G 5/00

(52) U.S. Cl. 345/427; 345/660; 345/649

(57) ABSTRACT

A method and apparatus are disclosed for monitoring the location of one or more viewer(s) and dynamically adjusting the image to compensate for the current location of the viewer(s). The image is adjusted to compensate for a viewing location (pan angle, Θ, tilt angle, Φ, or distance, d) outside of a specified range of values. The input image is adjusted so that the output image appears as originally intended, for the current viewing location of the viewer. A linear transformation technique is applied to the original image to generate a modified image. The linear transformation maps the pixels in the original image to a new space that distorts the image, such that when the modified image is viewed from an offset viewing location the image appears as if being viewed from a direct viewing location.

### FIELD OF THE INVENTION

The present invention relates to methods and apparatus for controlling a display, and more particularly, to a method and apparatus for automatically adjusting an image to compensate for an offset viewing location of a user.

### BACKGROUND OF THE INVENTION

The consumer marketplace offers a wide variety of devices for displaying images, such as televisions, portable DVD players and computer monitors. Most advances in display technology have been directed to techniques for reducing glare and reflection resulting from light sources and objects located in the vicinity of the display. Typically, image quality is improved by employing polarizing panels or screen coatings (or both) to reduce glare and reflections.

FIG. 1A illustrates a display 100 that is observed by a viewer 110 from a viewing location defined by a pan angle, Θ, tilt angle, Φ (not shown), and distance, d, relative to the display 100. Display devices are typically optimized for direct viewing by the viewer from a specified viewing distance. In the example of FIG. 1A, the viewer 110 is observing the display 100 from a distance, d, with a direct viewing angle where the pan and tilt angles, Θ and Φ, are approximately zero degrees.

If the viewer 110 is observing the display 100 from a pan angle, Θ, or tilt angle, Φ, (or both) that is offset from the intended direct viewing angle of the display 100, as shown in FIG. 1B, then the image will appear distorted to the viewer 110. Generally, if the viewer 110 is observing the display 100 from a pan angle, Θ, or tilt angle, Φ, (or both) that is offset from a predefined viewing angle of the display then the portions of the displayed image appearing on the opposite side of the image relative to the viewing location will appear smaller than when viewed from the intended direct viewing angle.

Similarly, if the viewer 110 is observing the display 100 from a distance, d, that is outside of the optimized viewing range of the display, then the image will likewise appear distorted to the viewer 110. Generally, if the viewer 110 is observing the display from a distance, d, beyond the optimized viewing range of the display 100, then the image will appear smaller to the viewer 110 than when viewed from the intended viewing range. It is further noted that as the size of the display area increases, the distortion caused by viewing the image from an offset position is more significant.

A need therefore exists for a method and apparatus for adjusting an image to compensate for an offset position of a viewer. A further need exists for a method and apparatus for adjusting an image to compensate for a viewing distance that is outside of an optimized viewing range of a display.

### SUMMARY OF THE INVENTION

Generally, a method and apparatus are disclosed for monitoring the location of one or more viewer(s) and dynamically adjusting the image to compensate for the current location of the viewer(s). In particular, the image is adjusted to compensate for a viewing location (pan angle, Θ, tilt angle, Φ, or distance, d) outside of a specified range of values. The present invention employs image processing techniques to adjust the input image so that the output image appears as originally intended, for the current viewing location of the viewer.

According to one aspect of the invention, the disclosed viewer-location image compensation system morphs an image to compensate for an offset pan angle, Θ, or tilt angle, Φ, (or both) to compress portions of the image nearest the viewer and enlarge portions of the image further from the viewer. Likewise, the disclosed viewer-location image compensation system scales an image to compensate for a viewing distance, d, outside of an optimized viewing range of a display (d<dₘᵢₙ or d>dₘₐₓ).

In order to compensate for an offset viewing location, the original image can be adjusted using a linear transformation technique to generate a modified image. Generally, the linear transformation maps the pixels in the original image to a new space that distorts the image, such that when the modified image is viewed from an offset viewing location the image appears as if being viewed from a direct viewing location.

A more complete understanding of the present invention, as well as further features and advantages of the present invention, will be obtained by reference to the following detailed description and drawings.

### BRIEF DESCRIPTION OF THE DRAWINGS

FIG. 1A is a top view illustrating a viewer observing a display from a direct viewing angle;

FIG. 1B is a top view illustrating a viewer observing a display from an offset viewing angle;

FIG. 2 is a schematic block diagram of a viewer-location image compensation system in accordance with the present invention; and

FIG. 3 is a flow chart describing an exemplary image adjustment process embodying principles of the present invention.

### DETAILED DESCRIPTION

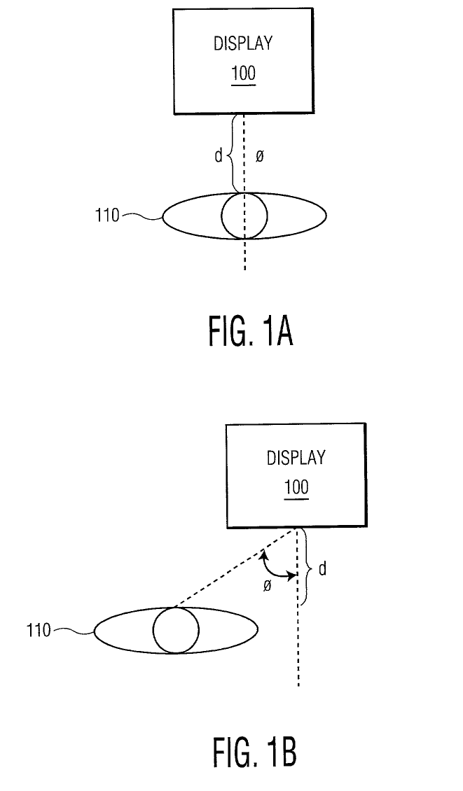

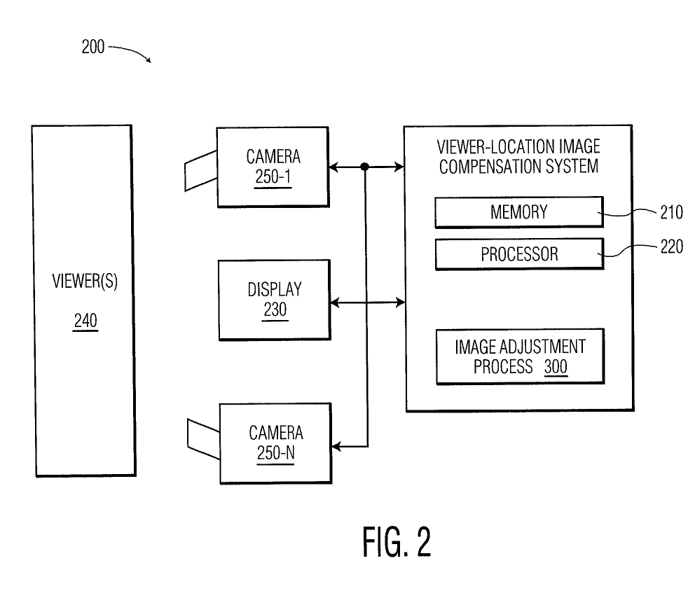

FIG. 1 illustrates a viewer-location image compensation system 200 in accordance with the present invention. As shown in FIG. 2, the viewer-location image compensation system 200 includes one or more cameras 250-1 through 250-N (hereinafter, collectively referred to as cameras 250) that are focused on one or more viewer(s) 240 of a display 230. The images generated by the cameras 250 are utilized to derive the viewing location of a viewer 240 (pan angle, Θ, tilt angle, Φ, and distance, d). The display 230 is any type of image or video display suitable for presenting images to the viewer 240 or for otherwise interacting with a human user, including liquid crystal displays (LCDs), projection systems and displays based on cathode-ray tube technology.

Generally, the viewer-location image compensation system 200 optimizes the image for the current location of a single viewer 240 or an average location of all viewers 240 in accordance with the present invention. The present invention optimizes an image for an offset viewing location of a viewer 240, where one or more of the pan angle, Θ, tilt angle, Φ, or distance, d, are outside a specified range of values. In this manner, the present invention employs image processing techniques to adjust the input image so that the output image appears as originally intended, for the current viewing location of the viewer 240.

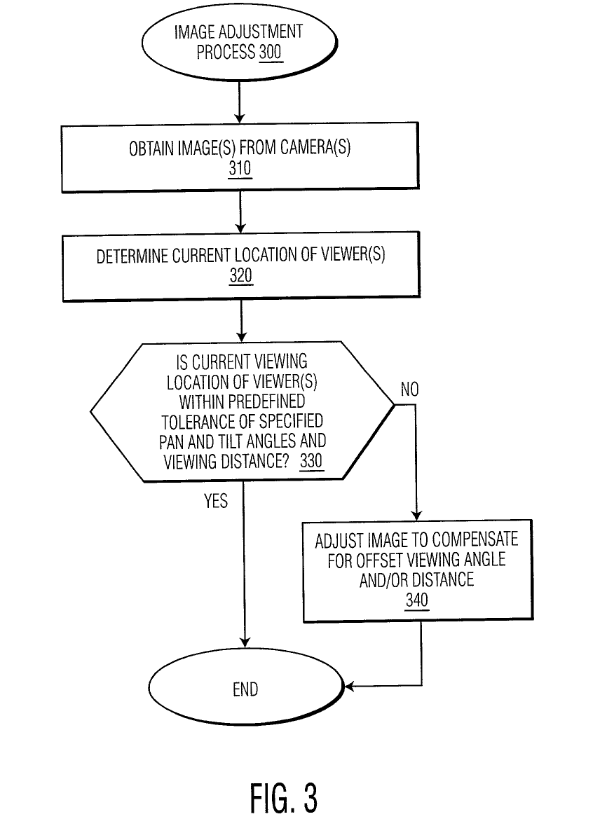

According to one feature of the present invention, the viewer-location image compensation system 200 adjusts an image to compensate for an offset viewing angle of a viewer. In particular, as discussed further below in conjunction with FIG. 3, the viewer-location image compensation system 200 morphs an image to compensate for an offset viewing pan angle, Θ, or tilt angle, Φ, to compress portions of the image nearest the viewer 240 and enlarge portions of the image further from the viewer 240. In this manner, the viewer-location image compensation system 200 allows an image viewed from an offset viewing angle (Θ≠0 or Φ≠0) to appear as if the image is viewed from a direct viewing angle (Θ and Φ approximately equal to 0).

According to another feature of the present invention, the viewer-location image compensation system 200 adjusts an image to compensate for a viewing distance, d, outside of an optimized viewing range of a display 230. In particular, as discussed further below in conjunction with FIG. 3, the viewer-location image compensation system 200 changes the size of an image to compensate for a viewing location, d, outside of an optimized viewing range of a display 230 (d<dₘᵢₙ or d>dₘₐₓ).

Thus, if the current viewing distance, d, is greater than the optimized region (d>dₘₐₓ), then the image is enlarged. Likewise, if the current viewing distance, d, is less than the optimized region (d<dₘᵢₙ), then the image is reduced. For example, the viewer-location image compensation system 200 can scale the image size to compensate for a viewing distance outside of the optimized viewing region. In an image having textual portions, for example, the size or thickness (or both) of the text can be adjusted. In this manner, the viewer-location image compensation system 200 allows an image viewed from a viewing distance, d, outside of an optimized viewing range of a display 230 to appear as if the image is viewed from a viewing distance, d, within the optimized viewing range of a display 230.

Each camera 250 may be embodied, for example, as a fixed or pan-tilt-zoom (PTZ) camera for capturing image or video information. The image information generated by the camera(s) 250 are processed by the viewer-location image compensation system 200, in a manner discussed below in conjunction with FIG. 3, to determine the viewing location of a viewer 240. It is noted that a one-camera system can estimate the viewing distance, d, based on the size of the person appearing in the image (assuming a standard size person).

The viewer-location image compensation system 200 may be embodied as any computing device, such as a personal computer or workstation, that contains a processor 220, such as a central processing unit (CPU), and memory 210, such as RAM and/or ROM. Alternatively, the viewer-location image compensation system 200 may be embodied as an application specific integrated circuit (ASIC) (not shown) that is included, for example, in a television, set-top terminal or another electronic device.

Memory 210 configures the processor 220 to implement the methods, steps, and functions disclosed herein. As shown in FIG. 2, the viewer-location image compensation system 200 includes an image adjustment process 300 that is implemented by the processor 220. Generally, the exemplary image adjustment process 300 monitors the location of one or more viewer(s) 240 and dynamically adjusts the image to compensate for the current location of the viewer(s) 240 in accordance with the present invention. The image adjustment process 300 can optimize an image for the current viewing location (pan angle, Θ, tilt angle, Φ, and distance, d) of a viewer 240.

The memory 210 could be distributed or local and the processor 220 could be distributed or singular. The memory 210 could be implemented as an electrical, magnetic or optical memory, or any combination of these or other types of storage devices. Moreover, the term “memory” should be construed broadly enough to encompass any information able to be read from or written to an address in the addressable space accessed by processor 220. With this definition, information on a network is still within memory 210 because the processor 220 can retrieve the information from the network. It should be noted that each distributed processor that makes up processor 220 generally contains its own addressable memory space.

FIG. 3 is a flow chart describing an exemplary image adjustment process 300. As previously indicated, the image adjustment process 300 monitors the location of one or more viewer(s) 240 and dynamically adjusts the image to compensate for the current location of the viewer(s) 240 in accordance with the present invention. The image adjustment process 300 may be executed continuously, intermittently or upon a detected movement of a viewer 240, as would be apparent to a person of ordinary skill in the art.

As shown in FIG. 3, the image adjustment process 300 initially obtains one or more images from the camera(s) 250 during step 310. Thereafter, the image adjustment process 300 determines the location of any viewer(s) 240 that are present during step 320. A test is performed during step 330 to determine if the current viewing location of the viewer(s) 240 is within a predefined tolerance of specified values for each of the pan angle, Θ, tilt angle, Φ, and distance, d.

If it is determined during step 330 that the current viewing location of the viewer(s) 240 is not within a predefined tolerance of a specified viewing location, then the image is adjusted during step 340 to compensate for the offset viewing angle or distance. An exemplary technique for adjusting the image to compensate for the offset viewing location of the viewer is described below in a section entitled “Image Adjustment Technique.”

If, however, it is determined during step 330 that the current viewing location of the viewer(s) 240 is within a predefined tolerance of a specified viewing location, then program control terminates.

### Image Adjustment Technique

The original image can be expressed as a two-by-two matrix of pixels. In order to compensate for an offset viewing location, the original image is adjusted in an exemplary embodiment of the present invention using a linear transformation technique. Generally, the linear transformation maps the pixels in the original image, I, to a new space to generate a modified image, M, that distorts the image, such that when the modified image is viewed from an offset viewing location the image appears as if being viewed from a direct viewing location. Thus, a given pixel in the original image can be expressed as P_{I} and a given pixel in the modified image can be expressed as P_{M}.

As previously indicated, the current viewing location is the current location of the viewer's eye, Pₑ, and is fully defined by the pan angle, Θ, tilt angle, Φ, and distance, d, relative to a fixed point on the display. the current location of the viewer's eye, Pₑ, can also be expressed as follows:

$${P}_{e} = R [ \begin{matrix}0 \\ 0 \\ d\end{matrix} ]$$

$$\text{where} R = [ \begin{matrix}cos Θ & 0 & - sin Θ \\ sin Φcos Θ & cos Φ & sin Φcos Θ \\ cos Φsin Θ & - sin Φ & cos Φcos Θ\end{matrix} ]$$

In a first embodiment, it is assumed that the user is far away from the display. The distance from the display can thus be ignored. Thus, each pixel in the modified image, P_{M}, can be obtained by identifying the appropriate index of a corresponding pixel in the original image, P_{I}. Thus, to obtain a pixel value in the modified image, the appropriate index of the corresponding pixel in the original image, P_{I}, is identified as follows:

$${P}_{I} = R \cdot {P}_{M} = R [ \begin{matrix}{x}_{0} \\ {y}_{0} \\ 0\end{matrix} ] .$$

Since this embodiment ignores the distance from the display, the corresponding pixel in the original image, P_{I}, can be expressed as follows

$${P}_{I} = ( \begin{matrix}{x}_{i} \\ {y}_{i}\end{matrix} ) .$$

In a second embodiment, the distance, d, of the user from the display is considered. Thus, to obtain a pixel value in the modified image, the appropriate index of the corresponding pixel in the original image, P_{I}, is identified as follows:

$${P}_{I} = R ( {P}_{M} - \frac{\text{<} {P}_{M} , {P}_{e} \text{>} ( {P}_{M} - {P}_{e} )}{\text{<} {P}_{e} - {P}_{M} , {P}_{e} \text{>}} ) . \\ \text{where} {P}_{M} = [ \begin{matrix}{x}_{0} \\ {y}_{0} \\ 0\end{matrix} ] .$$

It is noted that in both the first and second embodiments, if the calculated index of the corresponding pixel in the original image, P_{I}, is not an integer value image interpolation is used to obtain the pixel value at the appropriate pixel location.

As is known in the art, the methods and apparatus discussed herein may be distributed as an article of manufacture that itself comprises a computer-readable medium having computer-readable code means embodied thereon. The computer readable program code means is operable, in conjunction with a computer system to carry out all or some of the steps to perform the methods or create the apparatuses discussed herein. The computer-readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk.

It is to be understood that the embodiments and variations shown and described herein are merely illustrative of the principles of this invention and that various modifications may be implemented by those skilled in the art without departing from the scope and spirit of the invention.

What is claimed is:

1. A method for adjusting an image, comprising:
determining a viewing location of a viewer of said image; and
adjusting said image to compensate for a viewing location outside a predefined viewing range.

2. The method of claim 1, wherein said viewing location is outside a predefined viewing angle range.

3. The method of claim 1, wherein said viewing location is outside a predefined viewing distance range.

4. The method of claim 1, wherein said adjusting step further comprises the step of mapping pixels in said image to a new image space using a linear transformation that creates a distorted image such that when said distorted image is viewed from an offset viewing location said image appears as if being viewed from a direct viewing location.

5. The method of claim 4, wherein said linear transformation morphs said image to compensate for an offset viewing angle.

6. The method of claim 4, wherein said linear transformation scales said image to compensate for a viewing distance outside said predefined viewing distance range.

7. The method of claim 4, wherein said mapping of pixels to a new image space creates an image with a greater number of pixels using an interpolation technique.

8. A method for adjusting an image, comprising:
determining a viewing location of a viewer of said image; and
mapping pixels in said image to a new image space using a linear transformation that creates a distorted image such that when said distorted image is viewed from an offset viewing location said image appears as if being viewed from a direct viewing location.

9. The method of claim 8, wherein said viewing location is outside a predefined viewing angle range.

10. The method of claim 8, wherein said viewing location is outside a predefined viewing distance range.

11. The method of claim 8, wherein said mapping morphs said image to compensate for an offset viewing angle.

12. The method of claim 8, wherein said mapping scales said image to compensate for a viewing distance outside said predefined viewing distance range.

13. The method of claim 8, wherein said mapping of pixels to a new image space creates an image with a greater number of pixels using an interpolation technique.

14. A system for adjusting an image, comprising:
a memory for storing computer readable code; and
a processor operatively coupled to said memory (160), said processor configured to:
determine a viewing location of a viewer of said image; and
adjust said image to compensate for a viewing location outside a predefined viewing range.

15. The system of claim 14, wherein said processor is further configured to map pixels in said image to a new image space using a linear transformation that creates a distorted image such that when said distorted image is viewed from an offset viewing location said image appears as if being viewed from a direct viewing location.

16. The system of claim 15, wherein said new image space has a greater number of pixels obtained using an interpolation technique.

17. A system for adjusting an image, comprising:
a memory for storing computer readable code; and
a processor operatively coupled to said memory (160), said processor configured to:
determine a viewing location of a viewer of said image; and
map pixels in said image to a new image space using a linear transformation that creates a distorted image such that when said distorted image is viewed from an offset viewing location said image appears as if being viewed from a direct viewing location.

18. The system of claim 17, wherein said new image space has a greater number of pixels obtained using an interpolation technique.

19. An article of manufacture for adjusting an image, comprising:
a computer readable medium having computer readable code means embodied thereon, said computer readable program code means comprising:
a step to determine a viewing location of a viewer of said image; and
a step to adjust said image to compensate for a viewing location outside a predefined viewing range.

20. An article of manufacture for adjusting an image, comprising:
a computer readable medium having computer readable code means embodied thereon, said computer readable program code means comprising:
a step to determine a viewing location of a viewer of said image; and
a step to map pixels in said image to a new image space using a linear transformation that creates a distorted image such that when said distorted image is viewed from an offset viewing location said image appears as if being viewed from a direct viewing location.
